(19) United States
(12) Patent Application Publication
(10) Pub. No.: US 2004/0064457 A1
(43) Pub. Date: Apr. 1, 2004

(54) Mechanism for providing both a secure and attested boot

(76) Inventors: Vincent J. Zimmer, Federal Way, WA (US); Andrew J. Fish, Olympia, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/259,310

(22) Filed: Sep. 27, 2002

(51) Int. Cl. G06F 17/00

(52) U.S. Cl. 707/100

(57) ABSTRACT

In general, one embodiment of the invention involves a secure platform comprising a processor and a first memory containing a plurality of components. These components include at least a first core component and at least one platform-based component associated with the first core component. Under control by processor, pre-boot authentication is sequentially performed on the core components prior to passing control of the pre-boot authentication to that core component. Each core component authenticates platform-based components associated therewith.

### FIELD

Embodiments of the invention relate to the field of platform security.

### BACKGROUND

Advances in communication technologies with a platform have opened up many opportunities for applications that go beyond the traditional ways of doing business. Electronic commerce and business-to-business transactions are now being used more often in the global marketplace. Unfortunately, while electronic platforms like computers provide users with convenient and efficient methods of doing business, communicating and transacting, they are also vulnerable to unscrupulous attacks. Therefore, it is becoming more and more important to protect the integrity of data stored within or downloaded into a platform.

Various data security mechanisms may be used to protect the integrity of data exchanged between electronic platforms. One type of data security mechanism is referred to as isolated execution. “Isolated execution” involves logical and physical definitions of hardware and software components that interact directly or indirectly with an operating system at different operational modes. Each operational mode, referred to as a “ring,” is a logical division of hardware and software components that are designed to perform dedicated tasks within the operating system. Typically, for a platform, an innermost ring (Ring-0) would have the highest privilege level, encompassing the most critical, privileged components. The outermost ring, however, would have the lowest privilege level.

One disadvantage associated with isolated execution is that the integrity of hardware and software components is authenticated after boot operations by the platform. As a result, the integrity of the Basic Input/Output System (BIOS) or other key components associated with base functionality of the platform are not completed before analysis of components designed to enhance functionality of the platform.

In addition, isolated execution is not specifically designed to authenticate components provided by a wide array of vendors. For example, conventional BIOS is largely monolithic in construction. Otherwise, the BIOS device is subject to a greater risk of tampering. No implementation of platform firmware (of which BIOS is a distinguished subset) having a distributed implementation has been practical due to exacerbated security problems and an inability to define trusted relationships between various components.

### BRIEF DESCRIPTION OF THE DRAWINGS

The invention may best be understood by referring to the following description and accompanying drawings that are used to illustrate embodiments of the invention.

FIG. 1 is an exemplary embodiment of a platform utilizing the invention.

FIG. 2 is an exemplary embodiment of a pre-boot authentication process in providing a secure and/or attested boot by platform of FIG. 1.

FIG. 3 is a more detailed block diagram of an illustrative challenge-response authentication procedure performed by the platform of FIG. 1.

FIG. 4 is an exemplary embodiment of a signed manifest used during a pre-boot authentication procedure.

FIG. 5 is an exemplary embodiment of a digital signature based, pre-boot authentication procedure.

FIG. 6 is an exemplary embodiment of a hash-based pre-boot authentication scheme.

FIG. 7 is an exemplary embodiment of error handling for the pre-boot authentication procedure performed on an Attested Boot platform.

FIG. 8 is a detailed block diagram of an illustrative pre-boot authentication procedure performed by the platform of FIG. 2.

FIGS. 9A-9B are a detailed flowchart of the pre-boot authentication operations.

### DESCRIPTION

Various embodiments of the invention relate to a platform and method for providing both a secure and attested boot procedure configured to authenticate certain core components. A “core” component is hardware, software or firmware that is configured independent of any particular design of chipset or OEM motherboard. A “non-core” component is hardware, software or firmware that is based on configured specifically for a particular platform design or configured to reflect a policy of a vendor providing the component. After authentication, each core component may authenticate its non-core (e.g., platform-based) components prior to transferring control of Pre-boot Authentication Services to another core component or an Operating System (OS) loader.

In general, one embodiment of the invention provides a policy-based dispatch with unique core components (e.g., PEI/DXE cores described below) that can be signed by a manufacturer and built with a given set of tools, source code, etc., so that each core component has a given, trackable signature. By establishing a relationship of trust between core and non-core components, a platform can be developed with a distributed firmware topology. For instance, the platform may comprise (a) platform-independent, architecturally-defined core components with (b) security policy embodied in platform-specific, non-core components, and (c) sundry non-core components from independent hardware vendors, independent BIOS vendors and original equipment manufacturers that abstract chipsets, input/output devices and platform routing topology.

Certain details are set forth below in order to provide a thorough understanding of various embodiments of the invention, albeit the invention may be practiced through many embodiments other that those illustrated. Well-known logic and operations are not set forth in detail in order to avoid unnecessarily obscuring this description.

For example, a “platform” is an electronic system that features components which, when operable, collectively perform a desired function. Typical types of platforms include, but are not limited or restricted to a computer (e.g., desktop, a laptop, a hand-held, a server, a workstation, etc.), desktop office equipment (e.g., printer, scanner, a facsimile machine, etc.), a wireless telephone handset, a television set-top box, or even communication equipment (e.g., router).

According to one embodiment of the invention, a “component” is hardware, software, firmware or any combination thereof. For instance, in one embodiment of the invention, a component is binary information of which a collection of components forms the firmware of the platform. Each component may be a collection of sub-components, each having selected functionality.

Herein, software or firmware features code such as microcode, an operating system, an application, an applet or even a nub being a series of instructions. The code is stored in a machine readable medium, namely any medium that can store or transfer information. Examples of “machine readable medium” include an electronic circuit, a semiconductor memory device, a read only memory (ROM), a flash memory, an erasable programmable ROM (EPROM), a fiber optic medium, a radio frequency (RF) link, and any portable readable media such as a floppy diskette, a CD-ROM, an optical disk, a hard disk, etc.

A “link” is broadly defined as one or more information-carrying mediums (e.g., electrical wire, optical fiber, cable, bus, or air in combination with wireless signaling technology) to establish a communication pathway for the transmission of information. Information is considered to be data, address, control or any combination thereof.

A “one-way hash” is a function, mathematical or otherwise, that converts information from a variable-length to a fixed-length (referred to as a “hash value” or “digest”). The term “one-way” indicates that there does not readily exist an inverse function to recover any discernible portion of the original information from the fixed-length hash value. Examples of a hash function include MD5 provided by RSA Data Security of Redwood City, Calif., or Secure Hash Algorithm (SHA-1) as specified in a 1995 publication Secure Hash Standard FIPS 180-1 entitled “Federal Information Processing Standards Publication” (Apr. 17, 1995).

I. Architecture Overview

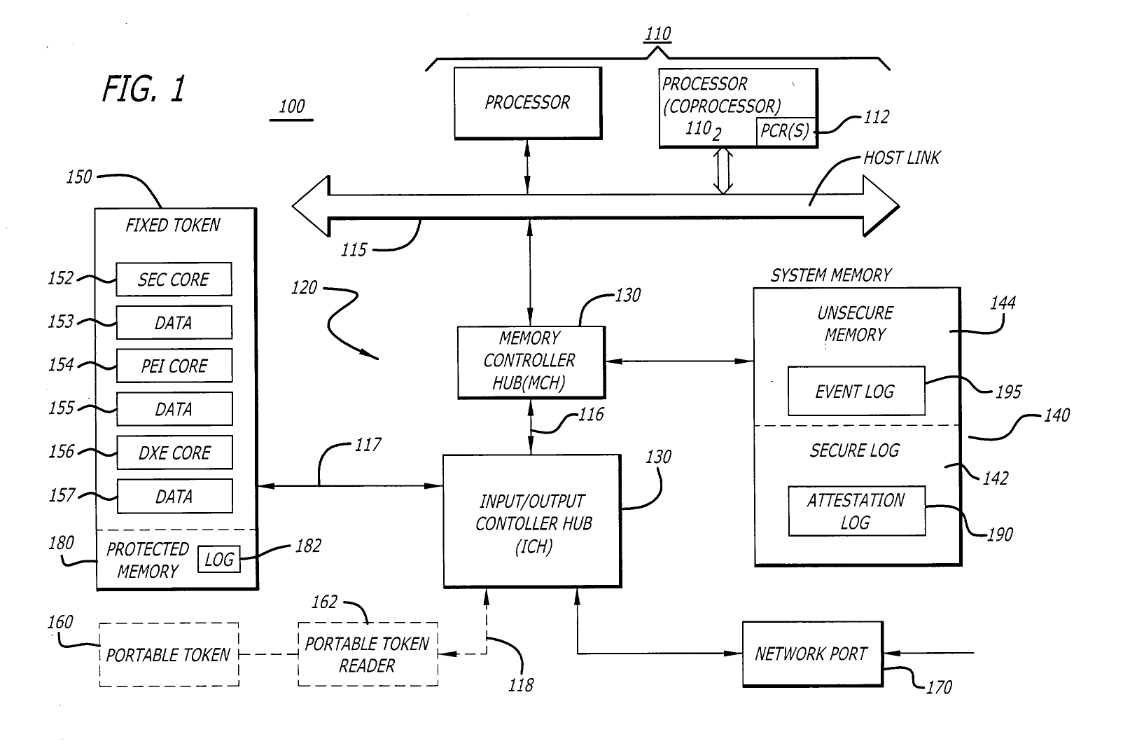

Referring to FIG. 1, a block diagram of an illustrative embodiment of a platform utilizing the invention is shown. In this embodiment of the invention, platform 100 comprises one or more processors 110, a chipset 120, a system memory 140 and one or more peripherals (e.g., a fixed token 150, an optional portable token 160, a network port 170). These logic components may be coupled to and mounted on a circuit board and interconnected by links 115-118.

Platform 100 may be configured to commence operations in accordance with a “secure boot” or an “attested boot” procedure, depending on the desired level of security. “Secure boot” platforms are adapted to preclude non-authenticated components from running. For instance, if the component is software or firmware and cannot be authenticated, platform 100 would prevent execution of such software or firmware, and perhaps disable or mitigate the operations of additional components. As a result, platform 100 may become inoperable or remain operable but with limited functionality (e.g., no access permitted to a local network over network port 170).

At a lesser level of security, “attested boot” platforms are permitted to execute the non-authenticated component, but an error is listed within an entry of an attestation log 190 placed in secure memory (e.g., secured area 142 of system memory 140, secure memory on fixed token 150, secure memory in one of processors 110, etc.). Memory is deemed “secure” when access privileges and restrictions are placed on the memory.

The “attestation log” 190 is information concerning the operating environment of platform 100; namely, a listing of data that represents what information has been successfully loaded into system memory 140 after power-on of platform 100. Each listing may include (1) a length (in bytes) of input data; (2) a pointer (32-bit physical address of the start of the data); (3) a length (in bytes) of a buffer referenced by the pointer; (4) a PCRindex being a PCR number to which the event is being logged; (5) a hash of the input data. At a later time, contents of attestation log 190 can be replayed for analysis as to the reasons for authentication failures and the scope of any security breaches as described below.

In addition, regardless of its type, platform 100 measures components and places the measured value within an event log 195, which is loaded in unsecure memory (e.g., unsecured area 144 of system memory 140, etc.). The term “measure” indicates the performance of one-way hash and placement of the resultant hash value into a non-resettable register, such as a Platform Configuration Register (PCR) 112 of one of processors 110 (e.g., coprocessor 110₂). Event log 195 indicates “what” was run: name and a fingerprint of the measured component. Herein, a “fingerprint” can be the one-way hash value.

As a result, a challenger, such as an OS Loader or other management application deciding to make a trust assertion with respect to platform 100, can replay contents of event log 195 and see if the replayed result matches fingerprint(s) stored in PCR(s) 112. If so, the components that the firmware launched have not been altered.

As shown in one embodiment of the invention, processor(s) 110 may be a central processing unit of any type of architecture, such as complex instruction set computers (CISC), reduced instruction set computers (RISC), very long instruction word (VLIW), or hybrid architecture. Of course, it is also contemplated that one or more of processors 110 (e.g., coprocessor 110₂) may be implemented as an application specific integrated circuit (ASIC), a digital signal processor, a state machine, a trusted platform component (TPM) in accordance with a recent specification by the Trusted Computing Platform Alliance entitled “Main Specification Version 1.1b” (Feb. 22, 2002) or the like. In the alternative, processor 110 may be a single unit supporting both CPU and some TPM functionality in lieu of a multi-processor platform as shown.

As shown in FIG. 1, a host link 115 is a front side bus that provides interface signals to allow processor 110 to communicate with other processors (if a multiple-processor platform) or chipset 120.

Herein, chipset 120 includes a memory control hub (MCH) 125 and an input/output control hub (ICH) 130 described below. MCH 125 and ICH 130 may be integrated into the same chip or placed in separate chips operating together via link 116.

With respect to MCH 125, it provides control and configuration of memory and input/output devices such as system memory 140 and ICH 130. System memory 140 stores code and data. System memory 140 is typically implemented with dynamic random access memory (DRAM), but may be implemented with any type of static RAM (SRAM)

For this embodiment of the invention, system memory 140 may be partitioned with a secured portion 142 and an unsecured portion 144. Secured portion 142 is an area with restricted access and such access is enforced by processor 110 and/or chipset 120. Unsecured portion 144 contains an operating system (OS) loader, namely a portion of the operating system that is typically loaded from a mass storage device via some boot code in a boot storage such as a boot read only memory (ROM). Of course, system memory 140 may also include other programs or data, which are not shown.

As further shown in FIG. 1, ICH 130 supports traditional input/output (I/O) functions. In this embodiment of the invention, ICH 130 supports fixed token 150, which may be implemented as non-volatile memory. Fixed token 150 is configured to store “M” core components along with data used to authenticate these components. For instance, the authentication data may include, but is not limited or restricted to signed manifests, digital signatures, digests, checksums and the like.

For this embodiment of the invention, fixed token 150 contains a core component to control platform 100 during a Security (SEC) phase (referred to as “SEC core” 152). Platform 100 enters into the SEC phase after power-up. Fixed token 150 further contains core components to control the platform during a Pre-Extendable Firmware Interface initialization (PEI) phase (referred to as “PEI core” 154) and/or during a Driver Execution (DXE) phase (referred to as “DXE core” 156). These core components 152, 154 and 156 are loaded within platform 100 along with their corresponding authentication data 153, 155 and 157, respectively.

The PEI core 154 includes a PEI core dispatcher (not shown), which is a sub-component of PEI core 154 configured to authenticate one or more PEI components. Likewise, The DXE core 156 includes a DXE core dispatcher (not shown), which is a sub-component of DXE core 156 configured to authenticate one or more DXE components.

It is contemplated that these core components 152, 154, 156 are platform independent and have a known signature for the binary when constructed for a given Instruction Set Architecture, which can include but is not limited to INTEL XSCALE®, IA32, and ITANIUM®.

In lieu of or in combination with fixed token 150, portable token 160 (e.g., a removable network interface card, compact disc “CD”, digital video disc “DVD”, floppy disk, etc.) may be loaded for storage of information associated with any one of the core components 152-157.

A token link 117 provides a communication path between ICH 130 and a fixed token 150 (e.g., a motherboard token) while optional token link 118 provides a communication path between ICH 130 and a token reader 162. Token reader 162 is adapted to receive and communicate with the portable token 160 having characteristics similar to a smart card. In general, both types of tokens are devices that perform dedicated I/O functions.

As shown in FIG. 1, data within attestation log 190 may be digests of each component loaded into system memory 140. These components may be software components such as SEC core 152, PEI core 154 and DXE core 156. Thus, attestation log 190 can act as a fingerprint that identifies information loaded into platform 100 and is used to attest or prove the current state of platform 100. It is contemplated, however, that attestation log 190 may be implemented into any type of secure (protected) memory such as memory of system memory 140, memory of fixed token 150, or separate, dedicated non-volatile memory.

II. Pre-Boot Authentication Process

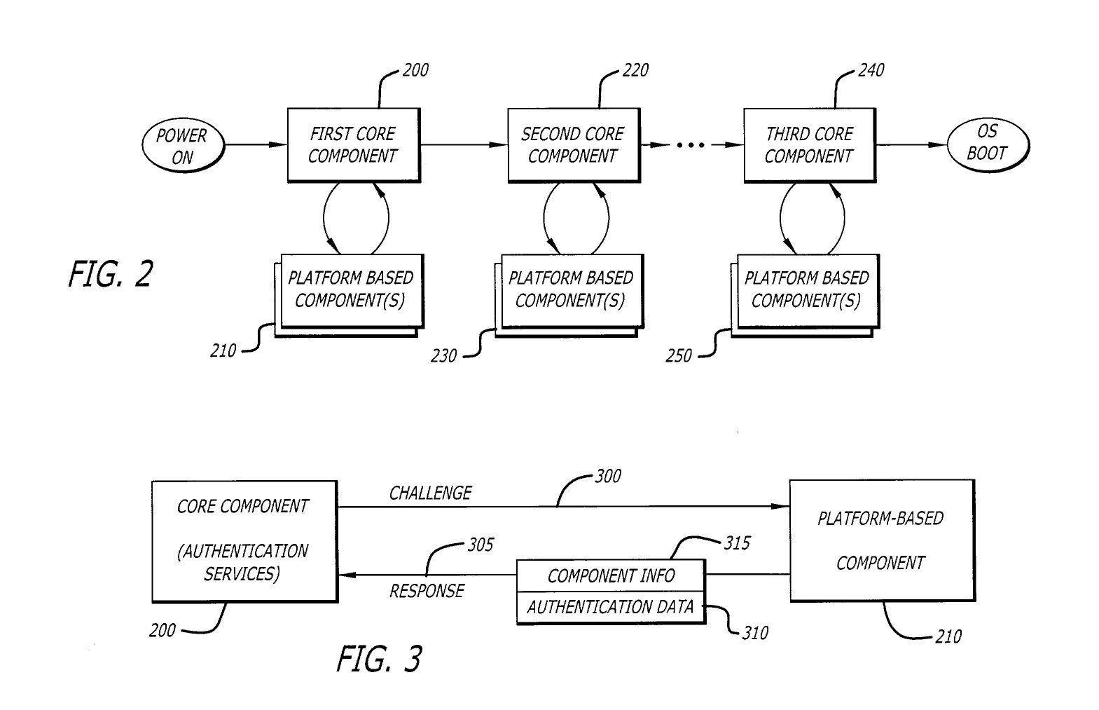

Referring now to FIG. 2, an exemplary embodiment of illustrative pre-boot authentication process in providing a secure and/or attested boot by platform 100 of FIG. 1 is shown. In response to a power-on reset condition, the platform enters into a Security (SEC) phase. During the SEC phase, a processor of the platform accesses a first core component 200 and performs pre-boot authentication operations thereon, prior to execution and passing control of the pre-boot authentication to first core component 200. For this embodiment of the invention, first core component 200 functions as a root of trust, namely the first code that is executed in a secure platform. First core component 200 may be microcode of processor 110 (e.g., coprocessor 1102) or SEC core as described below.

During the SEC phase, pre-boot authentication may be conducted through self-attestation. “Self-attestation” is a process by which a component checks itself by analyzing Built-in Self Test (BIST) information or self-signing, for example. Beyond self-attestation, there are two modes of platform-based attestation.

A first attestation mode is based on a processor vendor signing first core component 200 (e.g., SEC core) for the OEM platform builder. Upon each processor restart, microcode of the processor performs a signature check prior to passing control to initial opcode in first core component 200. A second attestation mode involves a service processor, such as cryptographic coprocessor (e.g., TPM) or a server management coprocessor, performing a signature check on first core component 200 and not releasing the platform from reset if the signature check fails. For both attestation modes, the first core component has a structure well-known to other agents so that manifest and signature information can be parsed. Once first core component 200 has been verified, the platform enters into the PEI phase.

During the PEI phase, pre-boot authentication operations are first performed on various non-core (platform-based) components 210 such as certain hardware initialization components for example. In one embodiment of the invention, the pre-boot authentication may involve an exchange of challenges and responses between the platform-based components 210 and the processor executing Authentication Services from first core component 200.

As shown in FIG. 3, in general, a “challenge” 300 is a message requesting particular data. Herein, challenge 300 prompts a response 305, namely a combination of information 315 pertaining to a component being authenticated (e.g., image, portion or entire component when software/firmware, etc.) and authentication data 310 associated with component information 315. Component information 315 may be in a compressed or uncompressed state. For this illustrative embodiment of the invention, component information 315 is equivalent to an executable image associated with one of platform-based components 210.

In the event that authentication data 310 features cryptographic elements, certain data from these elements is used to determine whether components or portions of the components have been corrupted. Authentication data 310 may include, but is not limited or restricted to a signed manifest, digital signature(s) and/or certificate(s), and/or digests in accordance with Hash function based Message Authentication Code “HMAC”. Of course, authentication data 310 may include other data types (e.g., checksum) besides those described below for illustrative purposes.

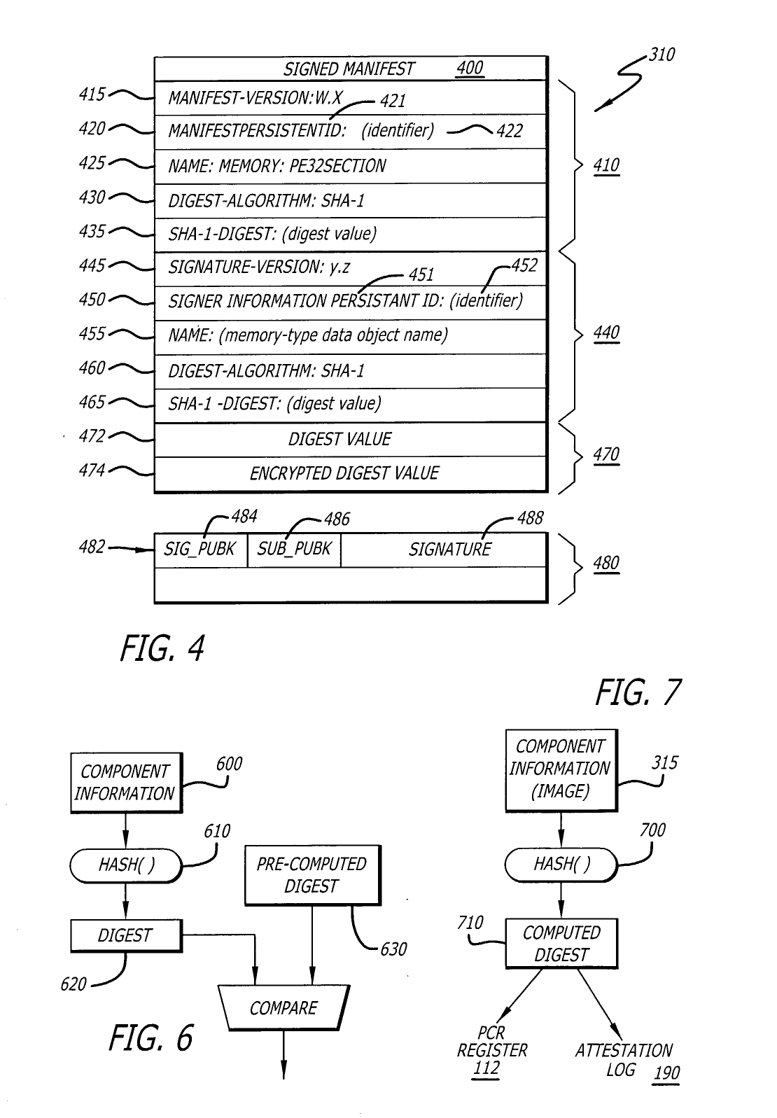

As shown in FIG. 4, for one embodiment of the invention, authentication data 310 comprises a signed manifest 400 and an accompanying certificate chain 480. A “signed manifest” is a verifiable listing of references to one or more components forming an executable image. One embodiment of the signed manifest 400 comprises a manifest segment 410, a signer's information segment 440 and a signature block segment 470.

Herein, the manifest segment 410 comprises a standard header 415, a manifest identifier 420, a memory section identifier 425, a digest algorithm identifier 430 and a digest field 435. Header 415 comprises a sequence of alphanumeric characters common to all manifest files such as “Manifest-Version: w.x” for this embodiment of the invention (where “w” and “x” are arbitrary integers). Manifest identifier 420 comprises a string “ManifestPersistentId:” 421 along with a unique identifier 422 for manifest segment 410. For FIG. 4, alphanumeric text in parentheses “( )” is merely a description of the information that should appear in the signed manifest.

Memory section identifier 425 [Name: memory:PE32Section] identifies a particular section of memory that contains the integrity data for the PE32 Section. Herein, for this embodiment of the invention, the integrity data is generally equivalent to a digest.

Digest algorithm identifier 430 [Digest-Algorithms: SHA-1] enumerates a digest algorithm for which integrity data is included for the data object. For systems with DSA signing, SHA-1 hash, and 1024-bit key length, the digest algorithm is selected to be “SHA-1” as shown. However, for platforms using RSA signing, MD5 hash and 512-bit key length, the digest algorithm is selected to be “MD5”. Multiple algorithms can be specified by separately listing each digest algorithm along with its corresponding value of the digest.

Digest field 435 [SHA-1-Digest: (digest)] provides a digest for a corresponding data object. In one embodiment of the invention, the value is a base64 encoded value.

Referring still to FIG. 4, signer's information segment 440 includes a header 445, a file identifier 450, a memory section identifier 455, a digest algorithm identifier 460 and a manifest digest field 465.

In particular, header 445 is a sequence of alphanumeric characters to indicate commencement of signer's information segment 440. This sequence comprises “Signature-Version: y.z” (where “y” and “z” are arbitrary integers).

File identifier 450 comprises a string of alphanumeric characters “SignerInformationPersistentId:” 451 along with a unique identifier 452 for signer's information segment 440.

Memory section identifier 455 [Name: (memory-type data object name)] identifies the particular section in signer's information segment 440 corresponding to the section with the section name in manifest segment 410.

Digest algorithm identifier 460 [Digest-Algorithms: SHA-1] enumerates the same digest algorithm as in the manifest segment 410.

Manifest digest 465 [SHA-1-Digest: (digest value)] provides a digest for manifest segment 410. In one embodiment of the invention, digest 465 is a base64 encoded value. Also, for the purpose of computing manifest digest 465, manifest segment 410 starts at the beginning of the opening “Name:” keyword and continues up to the next usage of a “Name:” keyword or an end-of-file.

A signature block 470 is a raw binary (not base64 encoded) that is placed in a defined format. Signature block 470 comprises a digest value 472 of signer's information segment 440 and an encrypted digest value 474. Encrypted digest value 474 generally operates as the signature of a subject who publishes certificate chain 480, which can be used to corroborate authenticity of the platform-based component. Signature block 470 is digitally signed with a private key of a signatory such as a provider of the component, manufacturer of the platform or any trusted third party.

Certificate chain 480 comprises at least one certificate 482 featuring a public key 484 of the signatory (SIG_PUBK), a “subject” public key 486 (SUB_PUBK) and a signature 488 of certificate 482. Certificate 482 may be configured in accordance with X.509v3 standard set forth in a “Request for Comments” (RFC) publication entitled “Internet X.509 Public Key Infrastructure Certificate and CRL profile” (January 1999) or International Telecommunications Unions (ITU) Standardization Sector “Data Networks and Open Communications Directory” (Recommendation X.509, November 1993).

Herein, SUB_PUBK 486 is necessary because certificate 482 will be signed by the subject's private key, and to corroborate the authenticity of certificate chain 480, SUB_PUBK 486 can be used for signature validation. SIG_PUBK 484 is so that a challenger, such as PEI or DXE core, can confirm an image was indeed signed by the given party.

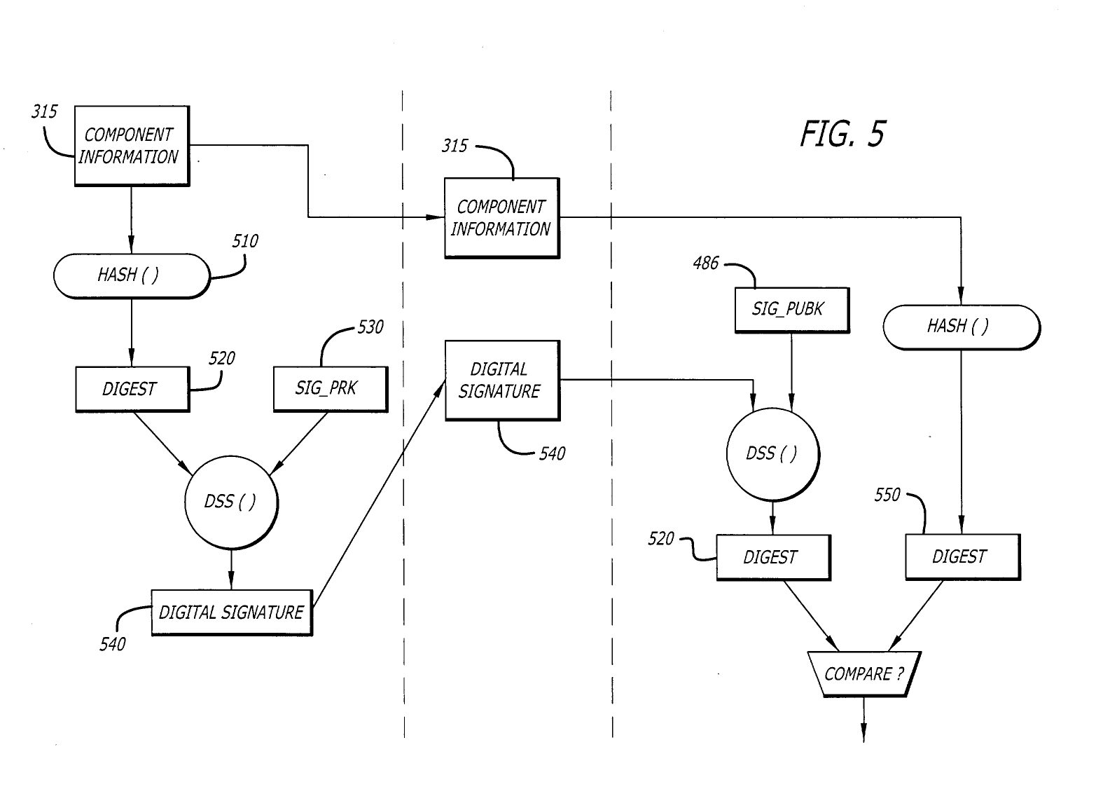

Referring now to FIG. 5, authentication data 310 used for pre-boot authentication may feature one or more digital signatures in lieu of a signed manifest of FIG. 4. For instance, component information 315, perhaps in a compressed state, may be accompanied by a digital signature 540. Digital signature 540 may be produced by the manufacturer of the platform, the original equipment manufacturer (OEM) of the core component, or another trusted third party (generally referred to as the “signatory”). In particular, digital signature 540 comprises a digest 520, which is based on a result of component information 315 undergoes a one-way hash function 510. Digest 520 is digitally signed using a private key (SIG_PRK) 530 of the signatory to produce digital signature 540.

For pre-boot authentication, digest 520 is recovered from digital signature 540 using a SIG_PUBK 486 of the signatory. This is compared with a digest 550 produced by running component information 315 through an identical one-way hash function. If digests 520 and 550 compare, component information 315 is authenticated and the component is safe to execute. Otherwise, the platform is placed into an error recovery state as described below.

Referring now to FIG. 6, authentication data 310 used for pre-boot authentication may feature digests in lieu of digital signatures of FIG. 5. For this pre-boot authentication procedure, component information 315 undergoes a one-way hash function 610 to produce a computed digest 620. Computed digest 620 is compared with a pre-computed digest 630. Pre-computed digest 630 accompanies the component during loading onto the platform or is produced during loading on the platform. If computed digest 620 matches pre-computed digest 630, the component is authenticated. Otherwise, the platform is placed into an error recovery state as described below.

In the event that a component cannot be authenticated, the platform is placed into an error recovery state. For a “secure boot” platform, the component is not executed. Where the component is a core component, pre-boot authentication controls are not passed to that core component. This may cause the platform to become inoperable or operable with limited functionality.

When the platform is configured as an “attested boot” platform, in one embodiment of the invention, execution and passing of operation control to the component is permitted, but an error is listed in an attestation log. More specifically, as shown in FIG. 7, an image of component 315 undergoes a hash operation 700 to produce a computed digest 710, which is loaded into both processor configuration registers (PCRs) of a Trusted Platform Component (TPM) as well as an entry of attestation log 190. The contents of attestation log 190 may be temporarily stored in a volatile memory (e.g., cache) until the full memory complement is initialized, and at that point the contents will be transferred to permanent memory (e.g., secured memory 142 of system memory 140 or memory 180 within a trusted token 150 of FIG. 1). At a later time, an OS loader or another manageability application will issue a “challenge” by replaying attestation log 190 to determine if such contents match values in the PCRs. If so, a trust assertion can be made to the component being authenticated.

Of course, as an alternative embodiment of the invention, it is contemplated that the platform can be configured to provide the user with an error warning in response to the component failing a pre-boot authentication procedure or not having authentication data associated therewith. This allows the user to select whether or not the pre-boot operations should proceed (whether the platform should operate as a “secure boot” platform or as an “attested boot” platform). A selection to proceed may involve the error being logged into an attestation log or deferring execution of the untrusted component via a Schedule On Request (SOR) or “UNTRUSTED” queue described below.

Referring back to FIG. 2, first core component 200 optionally authenticates a second core component 220 prior to passing control of the pre-boot operations thereto. Once second core component 220 has been authenticated, it performs pre-boot authentication operations on its non-core components 230. The pre-boot authentication procedure performed by each core component may be abstracted from another core component. Hence, code for performing pre-boot authentication operations can be shared between core components.

After completion of the PEI phase, the platform enters into a DXE phase where second core component 220 optionally authenticates a third core component 240 before passing control of the pre-boot authentication operations thereto. After successful authentication, third core component 240 authenticates its non-core components 250. This pre-boot authentication process continues for all of the core components implemented within the platform.

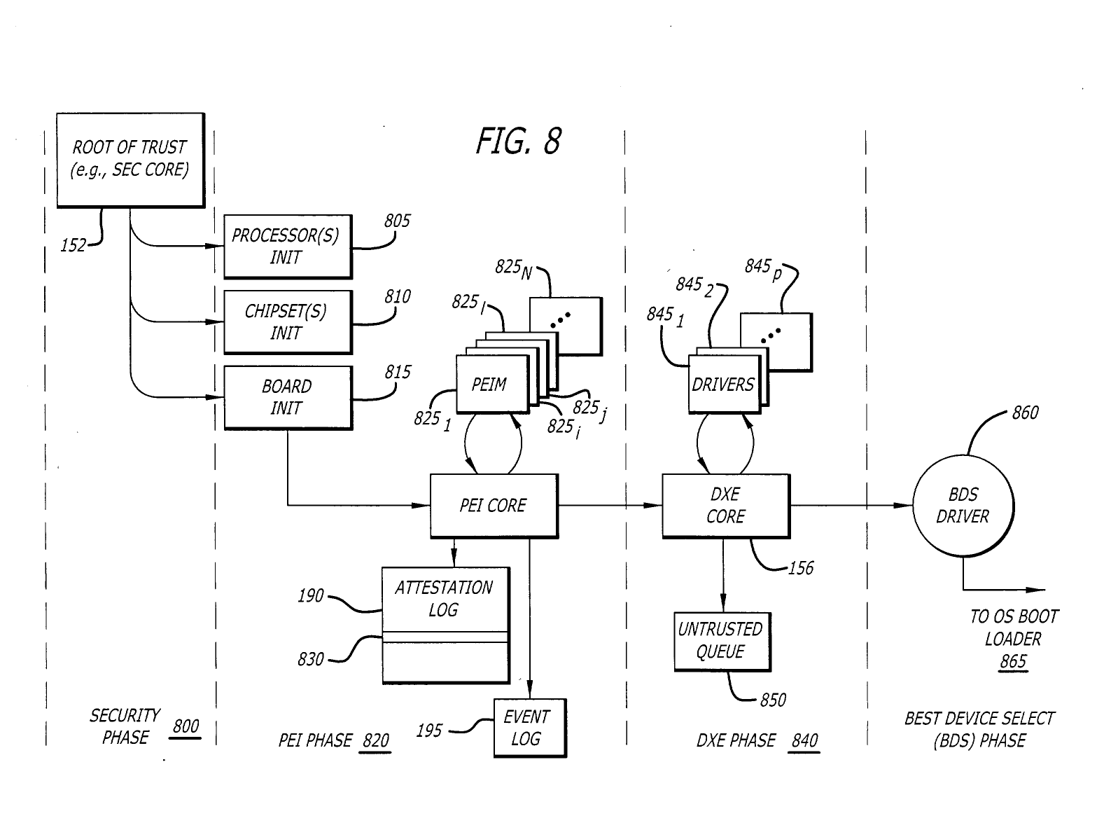

Referring now to FIG. 8, a more detailed block diagram of an illustrative pre-boot authentication procedure performed by the platform of FIG. 2 is shown. The pre-boot authentication is conducted by a processor of the platform. Prior to power-on, core and non-core components are placed within the platform along with corresponding authentication data (e.g., signed manifests, digital signatures, digests, checksums, or other data types).

In response to the power-on reset condition, a processor of the platform initially fetches an initial core component 152 for execution. This component 152 operates as the root of trust and may be SEC core as shown or perhaps microcode of one of processors 110 of FIG. 1. As software or firmware, SEC core 152 may be stored within read-only memory (ROM) or perhaps some type of memory having restricted access (e.g., restricted access portion of system memory).

During SEC phase 800, prior to execution and passing control of pre-boot authentication operations to SEC core 152, pre-boot authentication operations are performed on SEC core 152. Such authentication may be conducted through self-attestation as described above.

After being authenticated, SEC core 152 performs pre-boot authentication operations on platform-based components 210, namely hardware initialization sequences such as a processor init component 805, a chipset init component 810, board init component 815 and the like. In this embodiment of the invention, SEC core 152 also performs pre-boot authentication operations on PEI core 154, prior to passing control of the pre-boot authentication to PEI core 154. However, it is contemplated that PEI core 154 may be authenticated in a different manner than by SEC core 152.

PEI Core 154 is responsible for maintaining the boot state (normal boot, recovery, fast boot, flash update), orderly dispatching of PEI components (run correct code), challenge each component prior to running, making inquiries to a Security PEI-to-PEI interface (PPI) for disposition of a given component's authentication state, and ensuring that a PEIM does not run until all of its “dependencies” have been satisfied. A “dependency” is a state declaration of the services or PPIs that indicates what services or PPIs a PEIM will need so that these requisite services can be installed prior to invoking that PEIM.

During the PEI phase 820, once PEI core 154 has been authenticated, it performs pre-boot authentication operations on “N” PEI components (PEIM) 825₁-825_{N}, where N≧1. These pre-boot authentication operations are conducted using Authentication Services published by SEC core 152 through a PEI-to-PEI interface (PPI). The PPI for the authentication check and security corroboration can be published during SEC phase 800 and passed into PEI core 154. This allows SEC core 152 to use the authentication services in challenging PEI core 154, but to avoid PEI core 154 having to duplicate or rediscover these authentication services. As a result, code for performing challenge-response operations can be shared between core components.

The results of the pre-boot authentication are conveyed to one of the PEIMs 825ᵢ (“i” being a positive integer), namely a Security PEIM, which decides what to do in response to the authentication status, depending on whether the platform is configured as a “Secure Boot” platform or as an “Attested Boot” platform. For “Secure Boot” platforms, any non-authenticated PEIMs will not be executed. This may cause the platform to become inoperable. For “Attested Boot” platforms, in response to a failed authentication operation with a PEIM 825ⱼ (“j” being a positive integer; j i), the Security PEIM 825i will invoke an attestation PPI to create an entry 830 in attestation log 190 by performing a Hash-Extend operation on PEIM 825ⱼ and placing the result into secure memory of a component implemented within the platform (e.g., one or more platform configuration registers “PCRs” of the TPM). The result is also recorded in event log 195. Changes to security protocols and mechanisms may be made to the Security PEIM 825i without changing the core components.

At the end of the PEI phase 820, DXE core 156 is located. The Authentication Services from SEC core 152 can be used by DXE Initial Program Load PEIM 825₁ (“1” being a positive integer) to authenticate DXE core 156 prior to passing control of the pre-boot operations thereto. Any error or failure to authenticate can result in a crisis recovery or other exception handling deemed appropriate by Security PEIM 825ᵢ. This alternate behavior can be to simply “defer” the execution of the component in the PEI phase; this simple minded policy differs from the queuing of drivers found below in DXE phase since PEI is a simpler, more linear, phase of execution. If the control has been successfully ceded to DXE core 156, the process continues.

Now, during DXE phase 840, pre-boot authentication will be conducted by one of the drivers 845₁-845ₚ associated with DXE core 156 (referred to as the “Security Driver” 845₁). The security policy may be abstracted by a Security Architectural Protocol (SAP). The SAP is a platform/OEM specific embodiment of a security policy that allows the ability of a common DXE core to coexist with a given platform builder's policy direction. Prior to invoking any given driver, the SAP has an ability to create attestation log 190 or perform an event in response to a state of the driver. As an example, for an unsigned driver, SAP may lock-down flash, encrypt secrets (e.g., keys or other data), and perform other platform specific operations to enhance security of the platform before handing control to the unsigned driver.

Specifically, DXE Core 156 is a platform-agnostic, architecture based component that discovers and dispatches drivers 845₁-845ₚ. Prior to dispatching one of drivers 845₁-845ₚ, DXE core 156 assesses the ability of a component to be started immediately so that a driver is not dispatched prematurely. Since DXE core 156 only knows “how” to find drivers, it relies upon an extraction driver 845₂ to parse the crypto state of a signed driver (which there can be one for a given class of technology), but the “policy” as to what to do with a given driver with a given state is under the purview of a platform builder.

A low-cost platform that has no network connection may have a less stringent SAP (security policy) that allows execution of any component. This is due to the fact that there is no opportunity to introduce rogue code without violating physical security of the platform. However, a computer that is sold to a governmental agency may have more stringent requirements by requiring each driver to be signed and its signature check should be successful. It may also say that each driver will have an attestation log entry created by the SAP and trusted applications of the governmental agency will not run unless the attestation log for the pre-boot matches (as will attestation logs that an OS loader might create), etc. This scheme is to enable transitive trust. If A->B->C, where A is all BIOS components, B is OS loader, and C is the application, if any of the interleaving components are not trusted, then the trust chain is broken. The “untrusted” component compromises the integrity of the overall platform.

Upon failure of any of the “P” driver 845₂, . . . , or 845ₚ to be authenticated, Security Driver 845₁ can use a Schedule On Request (SOR) queue 850 to defer the launch of this untrusted driver. In addition, Security Driver 845₁ can take some exception handling, such as locking down all of the block-lockable flash regions in the firmware hub, prior to launching the untrusted driver. In addition, prior to launching a given driver, or in response therein, Security Driver 845₁ can invoke the TCPA Protocol to create additional attestation log entries.

DXE core 156 performs pre-boot authentication on a Boot Device Selection (BDS) driver 860 and passes pre-boot authentication control thereto. Then, BDS driver 860 attempts to process boot options. Prior to invoking an OS loader 865, a specific event occurs. If the platform resources have not been secured during DXE phase 840, the SAP will do so in the event handler prior to OS loader launch in that the platform state needs to be secured prior to this activity. Also, BDS driver 860 can assess the disposition of any untrusted drivers on SOR or UNTRUSTED queue 850 and dispatch them at this point as well. There shall be an additional DXE TRUST( ) service to allow for the dequeuing of a module from UNTRUSTED queue 850. The dequeue of a driver from UNTRUSTED queue 850 via the TRUST( ) service shall be performed by BDS driver 860 or another platform driver who, late in the boot process, has deemed it safe to invoke the deferred agent (e.g., the platform has been hardened already, etc).

Finally, in the case of an attested boot, the challenger (normally the OS loader or some higher-level agent wishing to make some trust decision with respect to the platform), can replay attestation log 190 of FIG. 1 in memory by performing the same Hash-Extend operation in software and verifying whether the results match the contents of the PCRs 112. If the results match, then the state of the platform matches that which the firmware recorded and there has been no intervening corruption thereof. The attestation log and associated PCRs provide the capability to make trust decisions with respect to the platform.

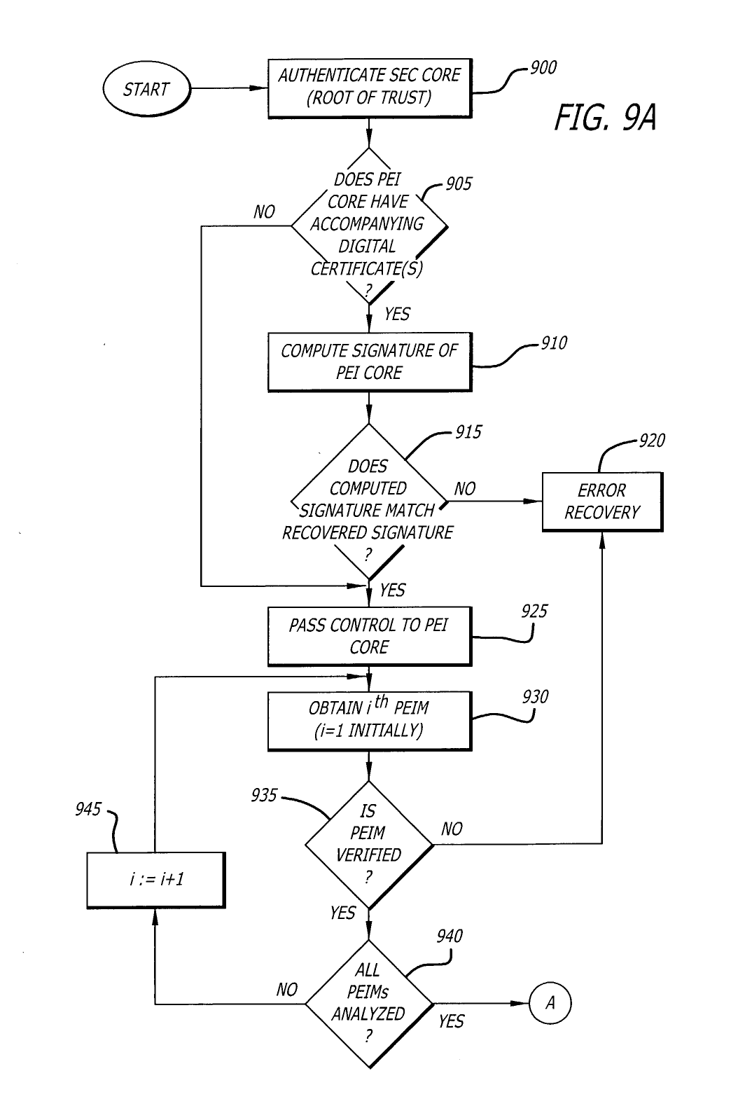

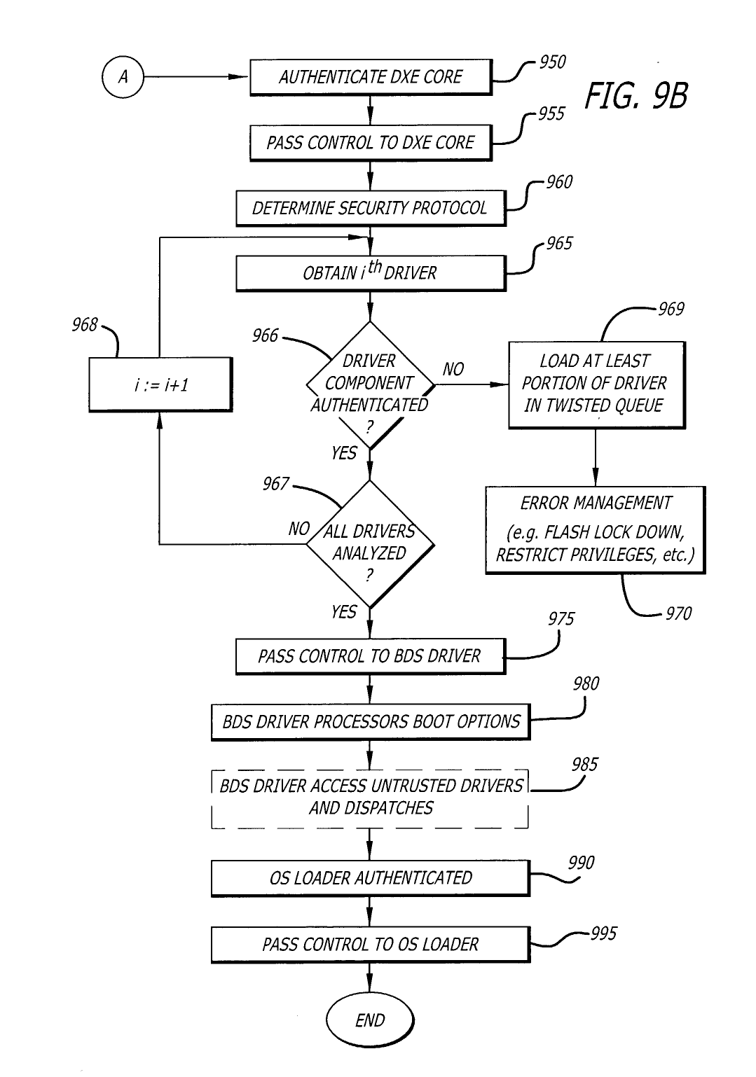

Referring now to FIGS. 9A-9B, a detailed flowchart of the pre-boot authentication operations is shown. Initially, a SEC core component, operating as a root of trust, is authenticated prior to involvement of the OS loader in performing boot operations (block 900). Prior to passing control of the pre-boot authentication procedure to a PEI core component, a determination is made whether the PEI core component includes a digital certificate (block 905). Herein, the digital certificate comprises at least a digital signature associated with the PEI core component certified using a private key of a trusted party.

If the digital certificate accompanies the PEI core component, a digital signature for the PEI core component is computed and compared with the digital signature recovered from the digital certificate (blocks 910 and 915). If a match is not detected, a selected error recovery procedure is performed (block 920). This may involve refusal to activate the PEI core component or activation of the PEI core component with loading of its digest into secure memory. However, if a match is detected, control is passed to the PEI core component (block 925).

If the digital certificate does not accompany the PEI core component, digital signature comparison operations set forth in blocks 910 and 915 are not performed. Instead, as one error recovery solution, a digest of the PEI core component may be loaded into secure memory to later trust analysis.

After the PEI core component has received control of the pre-boot authentication procedure, each PEI component (PEIM) operating in connection with the PEI core component is authenticated (blocks 930, 935, 940, 945). Such authentication may be conducted through challenge-response exchanges between the PEIM being authenticated and a PEI core dispatcher component having access to Authentication Services provided by the SEC core. Such exchanges may involve comparisons between computed and recovered data in signed manifest, digital signature or digests. If any of the PEIMs are not authenticated, the selected error recovery mechanism is used for handling such errors (block 920).

After all of the PEIMs have undergone pre-boot authentication and the DXE core has been authenticated, control is passed to the DXE core (blocks 950 and 955). The security protocol is determined before each DXE driver operating in connection with the DXE core component is authenticated (blocks 960, 965-969). Generally, the DXE core shall locate and obtain information from an interface to the Security Architectural Protocol (SAP) prior to dispatching any untrusted driver. A likely topology is to have “trusted” drivers in the flash part that were added as part of a signed, authenticated update, and untrusted drivers to be those drivers in flash that were not added as part of authenticated update or those drivers that are implemented on adapter cards and are not signed.

More specifically, as an illustrative embodiment of the invention, driver authentication may be conducted by the DXE Core calling a crypto driver to open an image associated with driver being authenticated (e.g., the crypto driver has published a GUID'd Section Extraction Protocol/PPI to do this extraction). The crypto driver provides the results of the DXE core. The DXE Core queries SAP, based on authentication status from crypto driver (GUID'd section extraction protocol/PPI), what to do with driver. SAP embodies platform-specific security policy and makes the logging, dispatch, defer, or other platform-specific decision. DXE Core effects the decision made by the SAP.

After all of the DXE drivers have undergone pre-boot authentication BDS driver has been authenticated, control is passed to the BDS driver (block 970). The BDS driver processes boot options. The processing of boot options entails parsing a list of device paths, namely binary strings that describe a path to a particular boot device. Examples of a “boot device” include, but are not limited to network devices, partitions on fixed disk, floppy drive, etc. There is some policy in the BDS driver as to which to try: timeout waiting for user-interaction to interrupt choice, etc.), accessing untrusted drivers and perhaps dispatching these drivers, or authenticating the OS loader and passes control of the OS loader or other agent to perform the boot procedure (blocks 980, 985, 990 and 995).

While the invention has been described in terms of several embodiments, the invention should not limited to only those embodiments described, but can be practiced with modification and alteration within the spirit and scope of the appended claims. The description is thus to be regarded as illustrative instead of limiting.

What is claimed is:

1. A platform comprising:
a first memory to contain a plurality of components including at least a first core component and at least one platform-based component associated with the first core component; and
a processor to perform pre-boot authentication operations on the first core component prior to passing control of the pre-boot authentication to the first core component to authenticate the at least one platform-based component.

2. The platform of claim 1, wherein the first core component to authenticate a second core component before passing control of the pre-boot authentication to the second core component.

3. The platform of claim 2, wherein the first core component is microcode stored in the first memory including at least on-chip memory of the processor.

4. The platform of claim 1, wherein the at least one platform-based component includes a hardware initialization sequence for a chipset.

5. The platform of claim 1, wherein the second core component abstracts Authentication Services from the first core component to perform pre-boot authenticate operations on platform-based components associated with the second core component.

6. The platform of claim 1, wherein the first core component is authenticated by analyzing Built-in Self Test (BIST) information.

7. The platform of claim 2, wherein the first core component to authenticate the second core component by the first core component (1) receiving at least a portion of the second core component and a signed manifest associated with the second core component, the signed manifest including a digest of at least the portion of the second core component, an identifier to indicate a particular section in the first memory that contains the digest, a signature block and a certificate chain, (2) using information recovered from the certificate chain to extract a pre-computed digest from the signature block, and (3) comparing the pre-computed digest to a digest produced for at least the portion of the second core component.

8. The platform of claim 2, wherein the first core component to authenticate the second core component by the first core component (1) receiving at least a portion of the second core component and a digital signature associated with the second core component, the digital signature including a pre-computed digest of at least the portion of the second core component digitally signed with a private key of a signatory producing the digital signature in which a public key of the signatory being accessible by the processor, (2) recovering the pre-computed digest, and (3) comparing the pre-computed digest with a digest produced for the received portion of the second core component.

9. The platform of claim 1 further comprising:
a second memory to contain an attestation log, the second memory being secured; and
a third memory to contain an event log, the third memory being unsecured.

10. The platform of claim 9, wherein the second memory includes registers within the processor.

11. The platform of claim 9, wherein the third memory is volatile memory.

12. The platform of claim 9, wherein the attestation log includes a plurality of listings each including data that represents what information has been successfully loaded into the first memory after power-on, at least one listing comprises a hash of the first core component.

13. The platform of claim 12, wherein the at least one listing of the attestation log further comprises (1) a length (in bytes) of the first core component, and (2) a pointer to a physical address denoting a start of the first core component.

14. A method comprising:
commencing a pre-boot authentication of components within a platform by performing a pre-boot authentication operation on a first core component; and
once the first core component has been authenticated,
(i) passing control of the pre-boot authentication to the first core component once the first core component has been authenticated, and
(ii) continuing performance of the pre-boot authentication under control of the first core component.

15. The method of claim 14, wherein the pre-boot authentication operation on the first core component includes analysis of Built-in Self Test (BIST) information associated with the first core component.

16. The method of claim 14, further comprising:
authenticating a second core component by the first core component; and
once the second core component has been authenticated,
passing control of the pre-boot authentication to the second core component, and
continuing performance of the pre-boot authentication under control of the second core component using Authentication Services published by the first core component.

17. The method of claim 16, wherein the authenticating of the second core component comprises:
receiving at least a portion of the second core component and a signed manifest by the first core component, the signed manifest including a digest of at least the portion of the second core component, and an identifier to indicate a particular section in a memory that contains the digest, a signature block and a certificate chain;
using information recovered from the certificate chain to extract a pre-computed digest from the signature block from; and
comparing the pre-computed digest to a digest produced for at least the portion of the second core component.

18. The method of claim 16, wherein the authenticating of the second core component comprises:
receiving at least a portion of the second core component and a digital signature associated with the second core component, the digital signature including a pre-computed digest of at least the portion of the second core component digitally signed with a private key of a signatory producing the digital signature in which a public key of the signatory being accessible;
recovering the pre-computed digest from the digital signature; and
comparing the pre-computed digest with a digest produced for the received portion of the second core component.

19. The method of claim 14, further comprising:
refusing to execute the first core component if the first core component has not been authenticated.

20. The method of claim 14, further comprising:
executing the first core component if the first core component has not been authenticated; and
performing an error recovery procedure to prevent modification of selected data within a programmable memory within the platform.

21. The method of claim 20, wherein the performing of the error recovery procedure further includes encrypting data stored within the platform.

22. The method of claim 14 further comprising:
creating an event log by storing a digest of the first core component in a non-resettable memory.

23. The method of claim 22 further comprising:
upon failing to authenticate the first core component, placing data in an entry of an attestation log contained in secure memory of the platform, contents of the attestation log being capable of replay.

24. Software stored in machine readable medium executed by internal circuitry within a platform to perform pre-boot authentication, the software comprising:
(a) a first component operating as a root of trust;
(b) a second component being authenticated by the first module prior to receiving control of the pre-boot authentication from the first component; and
(c) a third component being authenticated by the second component using Authentication Services published by the first component.

25. The software of claim 24, the second component authenticates the third component by (i) receiving at least a portion of the third component and a signed manifest, the signed manifest including a digest of at least the portion of the third component, and an identifier to indicate a particular section in a memory that contains the digest, a signature block and a certificate chain, (ii) using information recovered from the certificate chain to extract a pre-computed digest from the signature block from, and (iii) comparing the pre-computed digest to a digest produced for at least the portion of the second core component.

26. The software of claim 24, the second component authenticates the third component by (i) receiving at least a portion of the third component and a digital signature associated with the third component, the digital signature including a pre-computed digest of at least the portion of the third component digitally signed with a private key of a signatory producing the digital signature in which a public key of the signatory, (ii) recovering the pre-computed digest from the digital signature, and (iii) comparing the pre-computed digest with a digest produced for the received portion of the third component.

27. The software of claim 24 further comprising:
(d) a fourth component to perform one-way hash functions on a plurality of components undergoing the pre-boot authentication, including the first, second and third components, to produce a plurality of resultant digests each digest uniquely corresponding to one of the plurality of components and to place the plurality of resultant digests in a replayable event log located in internal memory of the platform, the fourth component further places any component undergoing the pre-boot authentication that is not authenticated in an attestation log located in secure memory of the platform.
